(19) United States
(12) Patent Application Publication
(10) Pub. No.: US 2007/0160868 A1
(43) Pub. Date: Jul. 12, 2007

(54) Brazing method and brazed structure

(75) Inventors: Haruhiko Watanabe, Obu-city (JP); Sumio Susa, Anjo-city (JP); Masaki Harada, Kariya-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/637,230

(22) Filed: Dec. 11, 2006

(30) Foreign Application Priority Data
Dec. 12, 2005 (JP) 2005-357818
Jul. 11, 2006 (JP) 2006-190861

(51) Int. Cl. B32B 15/20; B32B 15/18

(52) U.S. Cl. 428/675; 428/654

(57) ABSTRACT

A method of brazing different types of metals by a low melting point brazing material is provided. First, a surface of a first metal member is covered by a material enabling brazing with a second metal member along with diffusion of a brazing material. Next, a low melting point brazing material is arranged at the covered surface. Further, the low melting point brazing material is made to melt.

### TECHNICAL FIELD

The present invention relates to a method of brazing together different types of metals, more particularly relates to a brazing method enabling brazing using a low melting point brazing material.

### BACKGROUND ART

In brazing together different types of metals, to obtain a good brazability or solderability, the wettability of the brazing material at the surface of the matrix material is important. However, for example, the surface of stainless steel has tough oxides called “passive oxides”. Due to these passive oxides, the wettability of the brazing material is poor. Stainless steel is therefore known as a material difficult to braze.

In the past, various methods have been proposed for brazing together different types of metals. For example, it is known to plate the outer surface of stainless steel tubes with copper and braze copper fin plates to the copper (see Japanese Patent Publication (A) No. 7-80633). However, the copper plating parts melt to bond with the copper fin plates, so the temperature reaches as high as 1000° C. or more at the time of brazing. Therefore, the copper fins soften due to the high temperature and strength is liable to be lost. Further, there is also the technique of using a foil or paste of a nickel-based brazing material foil for brazing, but the brazing temperature becomes a high temperature and, further, the cost of the brazing becomes high.

Further, using a three-layer material of Al—Ni-SUS to bond stainless steel (SUS) and Al is known (see Japanese Patent Publication (A) No. 2002-336959), but in this case, the Ni layer has the function of preventing metal atoms of Al and SUS diffusing, so the stainless steel and aluminum are not brazed at a low melting point.

Further, it has been proposed to solder together stainless steel and aluminum members by forming a copper plating layer on the stainless steel, dipping this into a solder bath for aluminum members, and applying ultrasonic vibration to perform the soldering (see Japanese Patent Publication (A) No. 9-145270). This reaction is believed to be the following type of reaction. That is, if dipping copper plated stainless steel in a solder bath, the solder and copper form a layer made of intermetallic compounds and oxides. If applying ultrasonic vibration, this layer robs the oxygen from the oxides on the stainless steel surface and drops off from the stainless steel surface. The surface of the remaining stainless steel becomes oxide-free, that is, becomes a state easy to wet by solder and therefore able to be soldered. According to this proposed method, the copper plating of the stainless steel surface has the function of removing the oxides and is not left after the soldering. Further, since a solder bath and ultrasonic vibration are used, the soldering process requires additional facilities.

### DISCLOSURE OF THE INVENTION

The present invention was made in consideration of the above problems and has as its object to provide a novel brazing method and brazed structure enabling different types of metals to be brazed together by a low melting point brazing material.

A brazing method of a first aspect of the present invention has a step of covering a surface of a first metal member (121, 301) with a material (150, 302, 160) enabling brazing with a second metal member (101, 304) along with diffusion of a brazing material, a step of arranging a low melting point brazing material (201, 303) at said covered surface, and a step of making said low melting point brazing material (201, 303) melt. Therefore, according to the first aspect of the present invention, it becomes possible to braze together different types of metals in a furnace at a low temperature and prevent a drop in strength of the metal due to the high temperature at the time of brazing.

Said first metal may be made an iron-based material and said second metal a copper-based material. Further, as described in claim 3, said first metal may be made stainless steel and said second metal copper or a copper alloy. According to this, stainless steel and copper or a copper alloy can be brazed together at a low temperature.

The step of covering the surface of the first metal with the second metal may use plating or cladding. Further, said plating or cladding may be copper plating or copper cladding or Ni plating or Ni cladding. Further, said low melting point brazing material may be made a four-way copper brazing material. As a result, a four-way copper brazing material not able to be used in brazing stainless steel and copper-based material in the past can be used, and the drop in strength due to the high temperature of the copper during brazing can bed prevented.

A brazed structure according to a second aspect of the present invention is comprised of a first metal member (121, 301, 160) having a material enabling brazing with a second metal member (111, 304) along with diffusion of a brazing material and the second metal member (111, 304) brazed together by a low melting point brazing material (201, 303). According to the second aspect of the present invention, it is possible to provide a brazed structure brazed at a low temperature, so a brazed structure free from the concern over a drop in strength of the metal due to the high temperature at the time of brazing becomes possible.

In the second aspect of the present invention, said first metal member may be made iron-based and said second metal copper-based or said first metal may be made stainless steel and said second metal copper or a copper alloy. According to this, a brazed structure of stainless steel and copper or a copper alloy brazed together at a low temperature can be obtained, so a brazed structure free from the concern over a drop in strength becomes possible.

Further, said covered surface may be obtained by plating or cladding. In particular, said covered surface may be obtained by copper plating or copper cladding or Ni plating or Ni cladding. Further, said low melting point brazing material may be made a four-way copper brazing material.

Note the numbers in parentheses after the above members are examples of correspondence with the specific means set forth in the later explained embodiments.

### BRIEF DESCRIPTION OF THE DRAWINGS

FIG. 1 is a front view showing a heat exchanger according to a first embodiment of the present invention.

FIG. 2 is a view of the cross-section A-A of FIG. 1.

FIG. 3 is a view of the cross-section of the part B of FIG. 1.

FIG. 4 is a view showing the relationship between a header plate and tubes of a heat exchanger.

FIGS. 5(a) and (b) are views of cross-sections of a header tank of a heat exchanger.

FIG. 6 is a view of an example of brazing a header plate and tube of a heat exchanger.

FIG. 7 is a view of another example of brazing a header plate and tube of a heat exchanger.

FIG. 8 is a view of brazing of a tube and fins according to a second embodiment of the present invention.

FIG. 9 is a view of another example of brazing a header plate and tube of a heat exchanger.

### BEST MODE FOR CARRYING OUT THE INVENTION

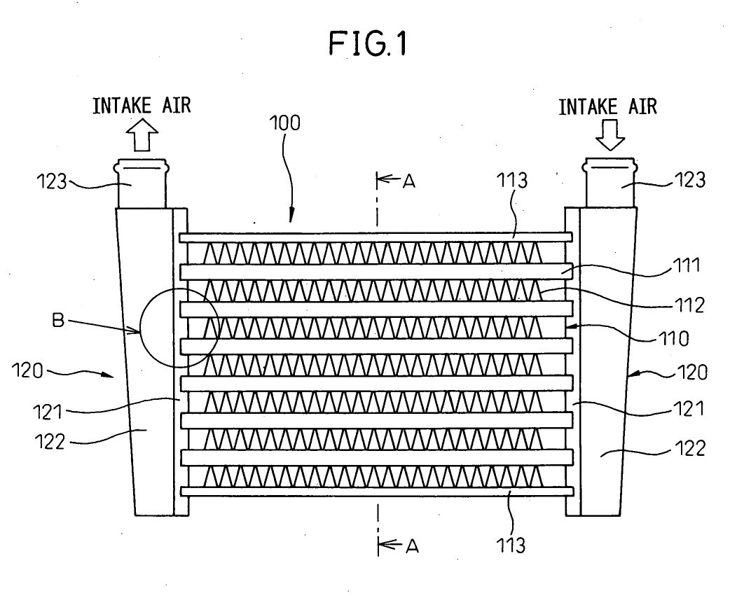

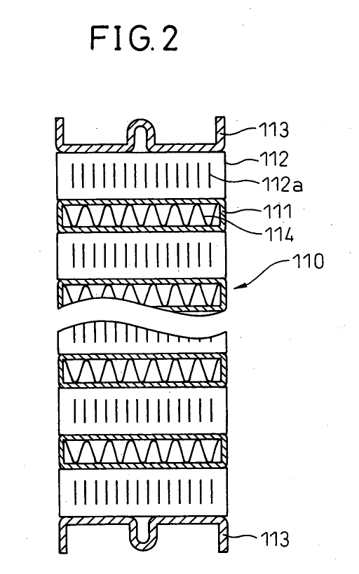

Below, embodiments of the present invention will be explained with reference to the drawings. FIG. 1 shows a heater exchanger, that is, an intercooler 100, to which the brazing method of the present invention is applied between a stainless steel header plate 121 and gold brass tubes 111, while FIG. 2 is a cross-section along A-A of FIG. 1.

The intercooler 100 cools the combustion use air sucked into a vehicular engine (internal combustion engine), that is, the intake, by heat exchange with cooling air from the outside. The intercooler 100 is comprised of a core part 110 and a pair of header tanks 120. The intercooler 100 shown as this embodiment is a large sized one mounted in a truck or other large sized vehicle. To obtain heat conductivity and durability, an iron-based material and copper-based material are used. The members are joined by brazing or welding. The brazing material used at the time of brazing is a low melting point four-way brazing material comprised of copper 75%, tin 15%, nickel 5%, and phosphorus 5%.

The core part 110 is comprised of tubes 111 in which inner fins 114 (FIG. 2) are inserted and outer fins 112 alternately stacked. At the outermost sides in the stacking direction, a pair of side plates 113 are provided. The tubes 111 are pipe members inside of which the intake air circulates and are configured as flat boxes in cross-sectional shapes so as to increase the cross-sectional areas as much as possible and reduce the flow resistance of the intake air in the limited space. Note that the tubes 111, while not illustrated in FIG. 2, are comprised of two tube-use plate members formed bent into U-shaped cross-sections and brazed together at the two mated U-shaped ends. The tubes are made of gold brass including 15% of zinc and 0.8% of iron.

The inner fins 114 inserted into the tubes 111 are comprised of a thin sheet material made of pure copper formed into corrugated shapes so as to give a turbulence effect to the flow of intake air and improve the heat transfer coefficient of the intake sides. The outer fins 112, like the inner fins 114, are comprised of a thin sheet material made of pure copper formed into corrugated shapes. The flat parts are provided with a plurality of louvers 112a by cutting and raising up parts of them so as to increase the heat radiating area at the cooling air sides. Heat exchange with the intake is promoted by the turbulence effect of the louvers 112a.

The side plates 113 are brass reinforcing members extending in the long directions of the tubes 111. They are formed to substantially U-shaped cross-sections and are provided with ribs extending in the long direction at the centers inside the U-shapes.

The core part 110 is formed by the component members brazed together. That is, the front and rear surfaces of the tube use plate members are precoated with a paste-like brazing material comprised of a brazing material and binder mixed together. The outer fins 112 and inner fins 114 are brazed to the tubes 111 by this brazing material. Further, the surfaces of the side plates 113 on the outer fin 112 sides are also coated with the paste-like brazing material. The outermost outer fins 112 are brazed by this brazing material to the side plates 113. Note that the brazing material may be changed from a paste-like brazing material to a foil brazing material. That is, the tubes 111 and outer fins 112 and inner fins 114 and, further, the side plates 113 and star fins 112 may be brazed by interposition of a foil brazing material.

The pair of header tanks 120 are provided at the ends 111a of the tubes 111. Each header tank 120 is comprised of a header plate 121 extending in the stacking direction of the tubes 111 and communicating with the tubes 111, a tank body 122, and a pipe 123.

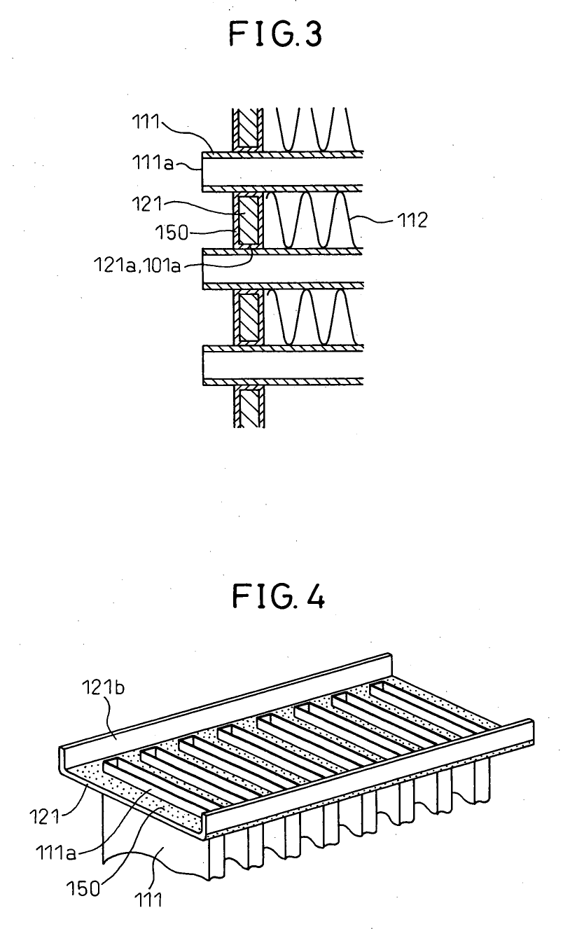

FIG. 3 is a cross-sectional view of the part B of FIG. 1. Further, FIG. 4 is a view for explaining the relationship of the tubes 11 brazed to the header plate 121. The inner fins 114 and outer fins 122 are omitted.

The header plate 121 is comprised of an elongated plate and has raised edges 121b at the outer circumference of the elongated plate. Further, the locations corresponding to the tube ends 111a are provided with tube holes 121a. The tube holes 121a are formed so that the tubes 111 may be fit into them by having them made just slightly larger than the cross-sectional shapes of the tubes 111. Further, the peripheral edges of the tube holes 121a at the sides where the tubes are inserted are chamfered. The header plate is comprised of stainless steel (SUS) and is plated with pure copper, except at the raised edges 121b, to form a copper covering 150 to enable brazing.

The tube ends 111a are inserted into the tube holes 121a and brazed there by a low melting point paste-like brazing material (brazing material comprised of brazing material and binder mixed together) coated on the engagement parts. That is, the tubes 111 and the plates 121 are brazed together at the mutually contacting abutting parts 101a. The header plates 121 (first metal members of the present invention) and the tubes 111 (second metal members of the present invention) form a brazed structure through the abutting parts 111a. Note that the two ends of the side plates 113 in the long direction are brazed to the header plates 121 by the brazing material coated on the parts abutting with the header plates 121.

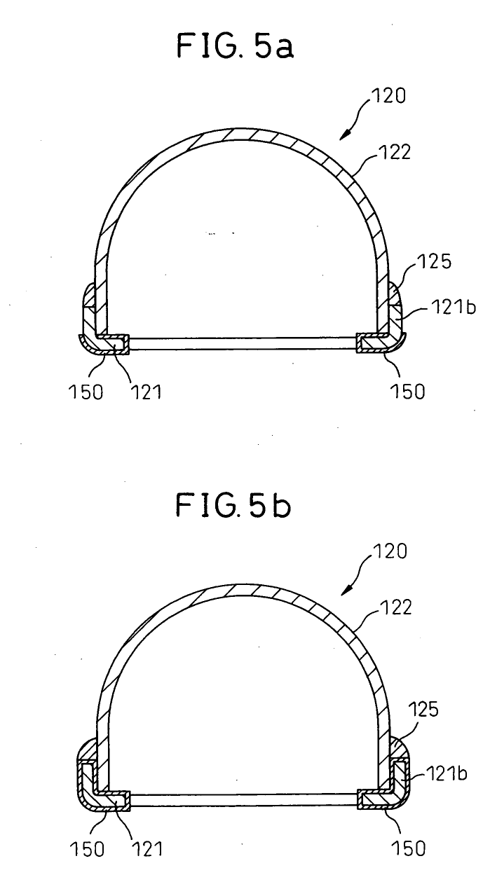

FIGS. 5(a), (b) are cross-sectional views of a header tank 120. The tank body 122 of each header tank 120 is comprised of stainless steel the same as the header plates 121 and, for example, is formed by press-forming. The tank body 122 is an elongated half container open at the header plate side. The open part is welded to the inner surfaces of the raised edges 121b of a header plate to form the inside space of the tank. The welding is, for example, performed by overlay fillet welding by arc welding such as TIG welding. Therefore, welding beads 125 are formed between the end faces of the raised edges 121b of the header plate 121 and the surface of the header tank 122. In FIG. 5(a), since a drop in strength of the weld zone might be a concern if the copper covering entered the weld zone in the weld process after the brazing process, the weld locations of the header plates 121, that is, the tops of the raised edges 121b, are not copper plated, but are left with the matrix material stainless steel exposed. However, as shown in FIG. 5(b), when the copper covering would not have any effect, for example, when the plating is thin and there would be little effect on the weld zone, the matrix material stainless steel need not be left exposed.

The pipes 123 (FIG. 1) are pipe members made of iron-based materials and are welded to first ends of the tank bodies 122 in the long direction so as to be communicated with the inside spaces of the tanks.

Next, the method of production of an intercooler 100 will be explained. First, tube-use plate members, side plates 113, and header plates 121 formed by press working a plate material and outer fins 112 and inner fins 114 formed by rolling are prepared.

Next, the front and back surfaces of the tube-use plate members and the surfaces of the side plates 113 at the outer fin 112 side are coated with a paste-like brazing material.

Further, using a stacking fixture (not shown) as a guide, one side plate 113 is set at the lowest side, then outer fins 112, tube-use plate materials, inner fins 114, tube-use plate materials, outer fins 112, and another side plate 113 are set above it to assemble the core part 10. At this time, the stacked tube-use plate members and inner fins 114 form tubes 111 with inner fins 114 inserted inside them.

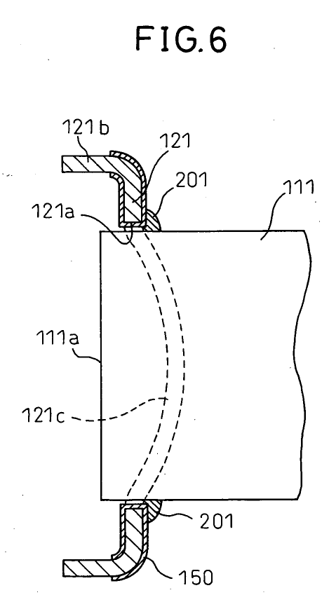

Next, as shown in FIG. 6, the ends 111a of the gold brass tubes 111 are inserted into the tube holes 121a of the header plates 121 and brazed there. Here, since the stainless steel header plates 121 have pure copper plating layers as constituted by the copper coverings 150, brazing by a low melting point brazing material is possible. Note that the header plates 121 have bulging parts 121c bulging out in dome-shapes to the tube 111 sides at the insides of the raised edges 121b.

At the time of brazing, the engagement parts where the ends 111a of the tubes 111 are inserted into the tube holes 121a of the header plates 121 are coated with a low melting point copper brazing material comprised of a paste-like brazing material 201 (brazing material comprised of brazing material and binder mixed together) made of a four-way brazing material (Cu—Ni—P—Sn). Note that if necessary, to hold the assembled state of the core part 110, wires etc. may be attached to the tubes 111 in the stacking direction. Further, the assembly is degreased, then inserted into a brazing furnace for brazing. The melting point of a four-way brazing material was about 600° C., while the furnace temperature was about 650° C.

In the past, if brazing stainless steel with copper using a low melting point copper brazing material, the wettability of the stainless steel was not sufficient and the brazing was difficult. Despite this, by coating the surface of the stainless steel with copper, it becomes possible to use a low melting point brazing material to braze stainless steel and copper—different types of metals. If being able to braze at a low melting point in this way, there is no softening of the copper due to the high temperature at the time of brazing and therefore there is no concern over a drop in strength.

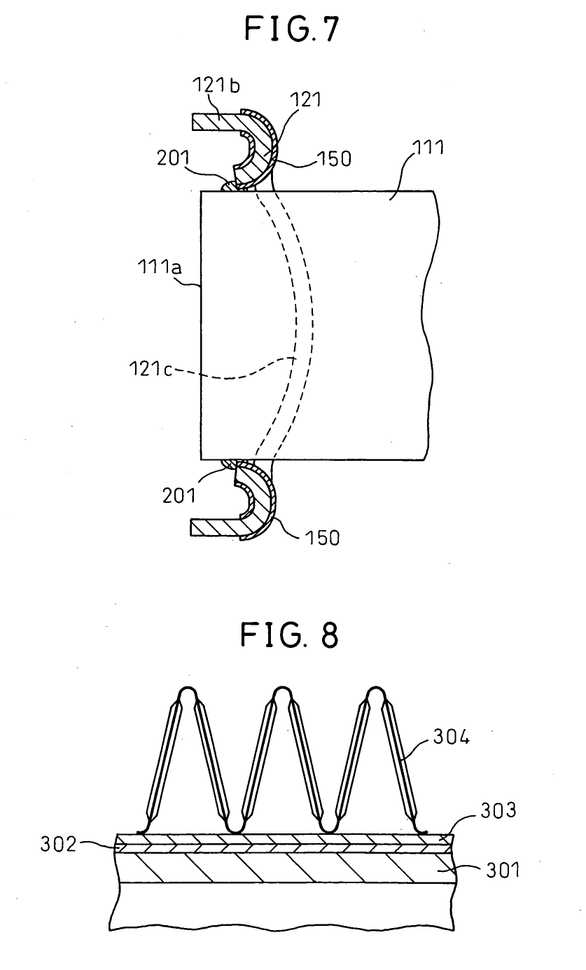

Note that the copper covering may also be obtained by cladding. FIG. 7 shows the case of using cladding. Stainless steel 121 covered with copper at its two sides by cladding is formed with insertion holes 121a by boring. According to this, when the tubes 111 are inserted into the holes, at the engagement parts, the outside surfaces of the gold brass tubes 111 face the copper coverings 150 obtained by cladding the copper on the stainless steel, so, as explained above, it is sufficient to coat a paste-like brazing material 201 comprised of a four-way brazing material (Cu—Ni—P—Sn) on the engagement parts, degrease the parts, then insert the assembly into a brazing furnace for brazing.

After the assembly of the header plates 121 and the core part 110 is formed, the tank bodies 122 have the pipes 123 welded to them. After this, the open sides of the tank bodies 122 are engaged with the raised edges 121b of the header plates 121 and the long direction ends of the tank bodies 122 and the raised edges 121b are overlay fillet welded.

In the above embodiment, the tubes 111 were made from gold brass. However, when strength or durability against corrosion is strongly demanded, the tubes are sometimes made from stainless steel. If making the tubes from stainless steel, it is necessary to braze copper fins to stainless steel tubes.

FIG. 8 shows a second embodiment of the present invention brazing copper fins 304 (corresponding to the second metal members of the present invention) to a stainless steel tube 301 (corresponding to the first metal member of the present invention). The stainless steel tube 301 is clad by copper to form a copper covering 302. The copper covering 302 is for example coated with a low melting point copper brazing material comprised of a paste-like brazing material 303 made of a four-way brazing material (Cu—Ni—P—Sn). The fins 304 are further placed on this and brazed in a brazing furnace. The furnace temperature is about 650° C. Note the procedure is similar even when providing fins in the tube as in the first embodiment.

According to this, the brazing can proceed at a low temperature and the drop in strength due to the softening of the copper can be prevented. Note that the copper covering 302 may also be obtained by plating. Further, the brazing material was coated on the copper covering 302 using a paste-like brazing material, but it is also possible to use a foil of low melting point copper brazing material, place it on the copper covering 302, then perform the brazing.

The above explained embodiment, as shown in FIGS. 6 to 8, positioned a low melting point brazing material on a copper covering 150, 302 formed on stainless steel for brazing. In the next explained embodiment, the copper covering 150, 302 is replaced with use of an Ni covering.

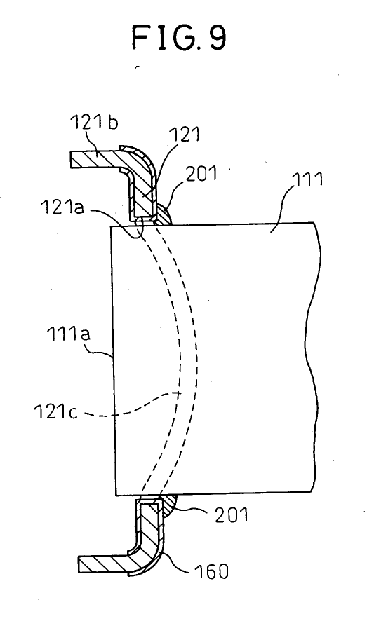

FIG. 9 shows an embodiment replacing the copper covering 150 of FIG. 6 with use of an Ni covering 160 obtained by Ni plating. Header plates 121 comprised of stainless steel of FIG. 9 have Ni coverings 160 obtained by plating layers of Ni and use the Ni coverings 160 for brazing with gold brass tubes 111. That is, ends 111a of the gold brass tubes 111 are inserted into tube holes 121a of the header plates 121 and the Ni coverings 160 are brazed by a low melting point brazing material.

As the low melting point brazing material, in the same way as shown in FIG. 6, it is possible to use a low melting point copper brazing material comprised of a four-way brazing material (Cu—Ni—P—Sn). The brazing process is also similar to that shown in FIG. 6. That is, the engagement parts comprised of the ends 111a of the tubes 111 inserted into the tube holes 121a of the header plates 121 are coated with a low melting point copper brazing material comprised of a paste-like brazing material 201 (brazing material comprised of brazing material and binder mixed together) made of a four-way brazing material (Cu—Ni—P—Sn). If necessary, to hold the assembled state of the core part 110, wires etc. may be attached to the tubes 111 in the stacking direction. Further, the assembly is degreased, then inserted into a brazing furnace for brazing. The melting point of a four-way brazing material was about 600° C., while the furnace temperature was about 650° C.

As shown in this embodiment, even if covering stainless steel with Ni by Ni plating, the stainless steel and copper, two different types of metals, can be brazed using a low melting point brazing material. Further, with a copper covering, when welding with other members is scheduled after brazing and the entry of the copper covering might cause the strength of the weld zone to drop, the later weld locations, that is, the raised edges 121b, are not covered with copper. However, with an Ni covering, when the stainless steel contains Ni, even if providing an Ni covering, the Ni covering will not cause a drop in the strength of the weld zone, so it is possible to plate the entire header plate 121 with Ni including the raised edges 121b, According to this, the plating process on the header plates 121 can be simplified.

Note the instead of the copper coating by the copper cladding of FIG. 7, it is also possible to use Ni cladding obtained by Ni. Further, instead of the copper coating 302 of FIG. 8, it is also possible to use an Ni coating.

As embodiments, examples of stainless steel and copper alloy were mentioned, but the present invention may also be applied to iron-based materials and copper-based materials. Further, as the low melting point brazing material, in addition to a four-way brazing material, a three-way or other low melting point brazing material may be used.

1. A brazing method for brazing together a first metal member and a second metal member different in type from said first metal member, said brazing method including
a step of covering a surface of the first metal member with a material enabling brazing with the second metal member along with diffusion of a brazing material,
a step of arranging a low melting point brazing material at said covered surface, and
a step of making said low melting point brazing material melt.

2. A brazing method as set forth in claim 1, wherein said first metal member is iron-based and said second metal member is copper-based.

3. A brazing method as set forth in claim 2, wherein said first metal member is comprised of stainless steel and said second metal member is comprised of copper or a copper alloy.

4. A brazing method as set forth in claim 1, wherein said covering step uses plating or cladding.

5. A brazing method as set forth in claim 4, wherein said plating or cladding is copper plating or copper cladding or Ni plating or Ni cladding.

6. A brazing method as set forth in claim 1, wherein said low melting point brazing material is a four-way copper brazing material.

7. A brazed structure comprised of a first metal member first metal member and a second metal member different in type from said first metal member,
said brazed structure characterized in that said first metal member having a covered surface of a material enabling brazing with the second metal member along with diffusion of a brazing material and said second metal member are brazed together by a low melting point brazing material.

8. A brazed structure as set forth in claim 7, characterized in that said first metal member is iron-based and said second metal is copper-based.

9. A brazed structure as set forth in claim 8, characterized in that said first metal is stainless steel and said second metal is copper or a copper alloy.

10. A brazed structure as set forth in claim 7, characterized in that said covered surface is a plating or cladding.

11. A brazed structure as set forth in claim 10, characterized in that said plating or cladding is a copper plating or copper cladding or Ni plating or Ni cladding.

12. A brazed structure as set forth in claim 7, characterized in that said low melting point brazing material is a four-way copper brazing material.
